(19) United States
(12) Patent Application Publication
(10) Pub. No.: US 2023/0373767 A1
(43) Pub. Date: Nov. 23, 2023

(54) SCISSORS-TYPE JACK

(71) Applicant: CHANGSHU TONGRUN AUTO ACCESSORY CO., LTD., Changshu (CN)

(72) Inventors: ZIHAO YIN, CHANGSHU (CN); YUANBO LIU, CHANGSHU (CN); CHENG MA, CHANGSHU (CN)

(21) Appl. No.: 17/873,849

(22) Filed: Jul. 26, 2022

(30) Foreign Application Priority Data
May 20, 2022 (CN) 2022105558292

(51) Int. Cl. B66F 3/12; B66F 3/44

(52) U.S. Cl. CPC B66F 3/12; B66F 3/44

(57) ABSTRACT

A scissors-type jack includes a jack body, a gear box, a motor and a battery pack. Upper ends of lower supporting arms of the jack body are respectively hinged to lower ends of upper supporting arms of the jack body through hinge shafts. The gear box includes a base, a housing, and first and second gears. The base is fixedly mounted with one hinge shaft. A gear transmission shaft of the first gear is rotatably arranged on the base and meshed with the second gear. The second gear is connected to a screw rod of the jack body. The motor is mounted on a side of the base, and a motor gear shaft penetrates through the base and is meshed with the first gear. The control board is disposed on an outer side of the battery pack and electrically connected to the battery pack and the motor.

### TECHNICAL FIELD

The invention relates to the field of jacking devices, and in particularly to a scissors-type jack.

### BACKGROUND

A scissors-type Jack, named for its shape like scissors, is an automobile accessory product of major domestic automobile factories, mainly used for jacking and supporting small tonnage automobiles such as cars. Most of existing mechanical scissors-type jacks achieve lifting and lowering through a manual operation of a rocker, so that an operation speed is slow and a labor intensity is high. An existing electric scissors-type jack is powered by a cigarette lighter and is driven by a motor to perform lifting operation, although an operation efficiency is improved, the existing electric scissors-type jack also has disadvantages that the automobile needs to be started when the cigarette lighter is used, and a connection wire for the cigarette lighter is long and thus it is inconvenient to store and easy to crush. There is a fuse inside an interface of the cigarette lighter, when overload occurs and a current is too large, the fuse will be blown to play the role of overload protection, and as a result, the fuse needs to be replaced to restore power supply. Moreover, a lifting range is limited in a mechanical manner, and thus the reliability is poor.

In view of the above existing technologies, it is necessary to improve structures of the existing scissors-type jacks, and for this reason, the inventors have made a beneficial design, and a technical solution will be introduced below is produced under this background.

### SUMMARY

A purpose of the invention is to provide a scissors-type jack, which is powered by a battery and thus is convenient for storage and can repeatedly carry out overload protection.

Specifically, the purpose of the invention can be realized as follows.

A scissors-type jack may include: a jack body, a gear box, a motor, and a battery pack. The jack body includes a bottom seat, a top support, a pair of lower supporting arms, a pair of upper supporting arms, and a screw rod. Lower ends of the pair of lower supporting arms are hinged to the bottom seat, upper ends of the pair of upper supporting arms are hinged to the top support, upper ends of the pair of lower supporting arms are respectively hinged to lower ends of the pair of upper supporting arms through a pair of hinge shafts, the screw rod penetrates between screw holes of the pair of hinge shafts, and the gear box is fixed to one of the pair of hinge shafts. The scissors-type jack further includes a control board. The gear box includes a base, a housing, a first gear, and a second gear. The base is fixedly mounted with the one of the pair of hinge shafts of the jack body, the housing is fitted with the base, and a side of the housing facing towards the base is formed with a gear box cavity. The first gear, the second gear and the battery pack are arranged on a side of the base facing towards the housing, a gear transmission shaft of the first gear is rotatably arranged on the base and engaged with the second gear, the second gear is connected to an end of the screw rod, the motor is mounted on a side of the base facing towards the jack body, and a motor gear shaft of the motor penetrates through the base and is engaged with the first gear. The control board is disposed on an outer side of the battery pack and electrically connected to the battery pack and the motor individually, and the control board is configured to control the motor to lift or lower the jack body.

In an embodiment of the invention, the control board is provided with an up key, a down key, and a switch key. The up key is configured to control the jack body to lift, the down key is configured to control the jack body to lower, and the switch key is configured to control the motor to be powered on or off.

In an embodiment of the invention, the control board is further provided with an overload protection chip, and the overload protection chip is configured to carry out overload current protection on the battery pack to thereby avoid overload use of the scissors-type jack.

In an embodiment of the invention, the scissors-type jack further includes a handle, the base is provided with a base handle shaft hole at a position close to the first gear, and the housing is provided with a housing handle shaft hole corresponding to the base handle shaft hole. The handle includes a gripping bar, a transverse bar, and a linkage bar. One end of the transverse bar is perpendicularly connected to the gripping bar, one end of the linkage bar is perpendicularly connected to the other end of the transverse bar and extends along a direction facing away from the gripping bar, the other end of the linkage bar is formed with a threaded section, an end of the threaded section is tapered to form a connecting shaft, the linkage bar penetrates through the housing handle shaft hole, the connecting shaft is inserted into the base handle shaft hole, and the threaded section is engaged with the first gear.

In an embodiment of the invention, the base is provided with a base bearing cavity at a position corresponding to the gear transmission shaft, a base bearing is arranged in the base bearing cavity, the housing is provided with a housing bearing cavity at a position corresponding to the base bearing cavity, a housing bearing is arranged in the housing bearing cavity, and two ends of the gear transmission shaft are respectively connected to the base bearing and the housing bearing.

In an embodiment of the invention, the scissors-type jack further includes a lowest position limit switch configured to limit a lowest position of lowering of the jack body and a highest position limit switch configured to limit a highest position of lifting of the jack body, the lowest position limit switch and the highest position limit switch are electrically connected to the control board individually.

Owing to the employment of the above structure, compared with the prior art, the invention may achieve beneficial effects as follows.

It can be used both manually and electrically, and a multistage transmission speed ratio exists between the handle or the motor and the screw rod, so that the operation is more labor-saving. Moreover, the motor is powered by the battery pack, which can avoid the problem that the connection wire is easy to be crushed when the cigarette lighter is used to supply power, and thus the recyclability is good. In addition, the control circuit has an overload protection function, when the jack is overloaded, the battery pack stops supplying power, so that the overload protection can be repeatedly realized, and the service life is prolonged. Furthermore, a lifting range is set through the limit switches, so that the position-limiting is accurate, and the use reliability is high.

### BRIEF DESCRIPTION OF DRAWINGS

FIG. 1 illustrates a schematic view of an overall structure of a scissors-type jack according to an embodiment of the invention.

FIG. 2 illustrates a schematic view of a lifted state of the scissors-type jack according to an embodiment of the invention.

FIG. 3 illustrates a schematic view of a lowered state of the scissors-type jack according to an embodiment of the invention.

FIG. 4 illustrates a schematic electrical connection diagram of a control board according to an embodiment of the invention.

### DESCRIPTION OF REFERENCE NUMERALS IN THE DRAWINGS

1-jack body, 11-bottom seat, 12-top support, 13-lower supporting arm, 14-upper supporting arm, 15-screw rod, 16-hinge shaft, 2-gear box, 21-base, 211-base handle shaft hole, 212-base bearing cavity, 213-base bearing, 22-housing, 221-gear box cavity, 222-housing handle shaft hole, 223-housing bearing cavity, 224-housing bearing, 23-first gear, 231-gear transmission shaft, 24-second gear, 3-motor, 31-motor gear shaft, 4-battery pack, 5-control board, 51-up key, 52-down key, 53-switch key, 54-overload protection chip, 55-battery level indicator lamp, 6-handle, 61-gripping bar, 62-transverse bar, 63-linkage bar, 631-threaded section, 632-connecting shaft, 7-lowest position limit switch, and 8-highest position limit switch.

### DETAILED DESCRIPTION OF EMBODIMENTS

Specific embodiments of the invention will be described below in detail with reference to the accompanying drawings, but the description of the embodiments is not a limitation of technical solution, and any form change rather than substantive change based on the concept of the invention should be regarded as the scope of protection of the invention.

In the following description, all concepts involving orientations such as up, down, left, right, front and back all are relative to positional states of the drawings being described, which are intended to facilitate public understanding, and are not to be construed as special limitations of technical solutions provided by the invention.

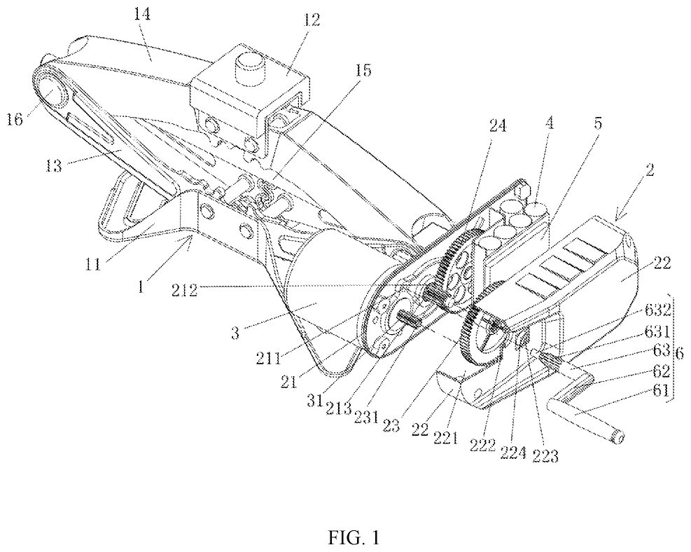

As illustrated in FIG. 1 through FIG. 3, a scissors-type jack according to an embodiment of the invention includes: a jack body 1, a gear box 2, a motor 3, a battery pack 4, and a control board 5. The jack body 1 includes a bottom seat 11, a top support 12, a pair of lower supporting arms 12, a pair of upper supporting arms 14, and a screw rod 15. Lower ends of the pair of lower supporting arms 13 are hinged to the bottom seat 11, upper ends of the pair of upper supporting arms 14 are hinged to the top support 12, upper ends of the pair of lower supporting arms 13 are respectively hinged to lower ends of the pair of upper supporting arms 14 through a pair of hinge shafts 16, and the screw rod 15 penetrates through screw holes of the pair of hinge shafts 16. The gear box 2 is fixed with one of the hinge shafts 16. The gear box 2 includes a base 21, a housing 22, a first gear 23, and a second gear 24. The base 21 is fixedly mounted with the one of the hinge shafts 16 of the jack body 1, the housing 22 is fitted with the base 21, and a side of the housing 22 facing towards the base 211 is formed with a gear box cavity 221. The first gear 23, the second gear 24 and the battery pack 4 are arranged on a side of the base 21 facing towards the housing 22. A gear transmission shaft 231 of the first gear 23 is rotatably disposed on the base 21 and engaged (e.g., meshed) with the second gear 24. Specifically, the base 21 is provided with a base bearing cavity (also referred to as bearing receiving cavity of base) 212 at a position corresponding to the gear transmission shaft 231, a base bearing (also referred to bearing of base) 213 is arranged in the base bearing cavity 212, the housing 22 is provided with a housing bearing cavity (also referred to as bearing receiving cavity of housing) 223 at a position corresponding to the base bearing cavity 212, a housing bearing (also referred to as bearing of housing) 224 is arranged in the housing bearing cavity 223, and two ends of the gear transmission shaft 231 are respectively connected to the base bearing 213 and the housing bearing 224. The second gear 24 is connected to an end of the screw rod 15. The motor (also referred to as electric motor) 3 is mounted on a side of the base 21 facing towards the jack body 1, a motor gear shaft 31 of the motor 3 penetrates through the base 21 and is engaged (e.g., meshed) with the first gear 23. The control board 5 is disposed on an outer side of the battery pack 4 and electrically connected to the battery pack 4 and the motor 3 individually. The battery pack 4 is configured (i.e., structured and arranged) to supply power to the control board 5, and the control board 5 is configured to control an operation of the motor 3. When the motor 3 rotates, the motor gear shaft 31 drives the first gear 23 to rotate, the first gear 23 drives the second gear 24 to rotate through the gear transmission shaft 231, the second gear 24 drives the screw rod 15 to rotate, so that the pair of hinge shafts 16 move toward or away from each other along the screw rod 15, thereby realizing a lifting operation or a lowering operation of the jack body 1. In an illustrated embodiment, the battery pack 4 is preferably a 18650 lithium battery, but the invention is not limited to this. The 18650 lithium battery has a large capacity, long service life, and very high safety performance in work. The battery pack 4 is arranged in the gear box 2 and is small in size and stable for power supplying.

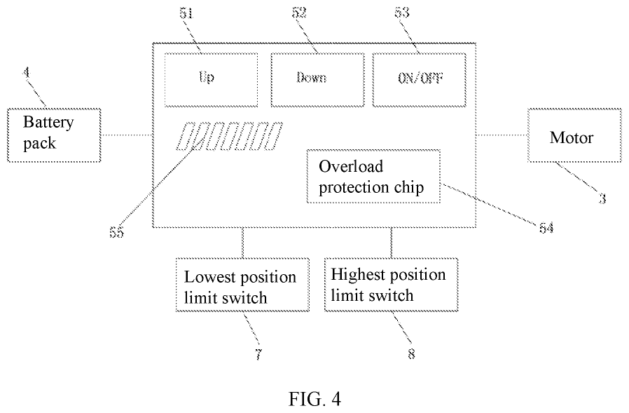

As illustrated in FIG. 4, specifically, the control board 5 is disposed with an up key 51, a bottom key 52, and a switch key 53. The up key 51 is configured to control a lifting operation of the jack body 1, the down key 52 is configured to control a lowering operation of the jack body 1, and the switch key 53 is configured to control power on or off of the motor 3. A core of the control board 5 may be a single chip microcomputer (SCM) and related peripheral circuits, and connections and applications of the control board 5 with the above keys have been disclosed in many ways in the prior art, and thus details are omitted herein.

Moreover, in some embodiments, the control board 5 is further disposed with an overload protection chip 54, and the overload protection chip 54 is configured to carry out current overload protection on the battery pack 4. In an illustrated embodiment, the overload protection chip 54 is SH39F323 produced by Sino Wealth Electronic Ltd., but is not limited to this type of chip. When the jack body 1 is overloaded and the current exceeds a certain ampere, the battery pack 4 stops supplying power, and at this situation, the power can be supplied again only by pressing the switch key (also referred to as on-off key) 53, so that the use safety is high and the operation is more convenient. The control board 5 may be further provided with a battery level indicator lamp 55 for displaying a battery level of the battery pack 4 in real time.

In addition, in some embodiments, the scissors-type jack further includes a handle 6, the base 21 is provided with a base handle shaft hole (also referred to as handle shaft receiving hole of base) 211 at a position close to the first gear 23, and the housing 22 is provided with a housing handle shaft hole (also referred to as handle shaft receiving hole of housing) 222 corresponding to the base handle shaft hole 211. The handle 6 includes a gripping bar 61, a transverse bar 62, and a linkage bar 63. One end of the transverse bar 62 is perpendicularly connected to the gripping bar 61, and one end of the linkage bar 63 is perpendicularly connected to the other end of the transverse bar 62 and extends in a direction facing away from the gripping bar 61. The other end of the linkage bar 63 is formed with a threaded section 631, and an end of the threaded section 631 is tapered to form a connecting shaft 632. The linkage bar 63 penetrates through the housing handle shaft hole 222, the connecting shaft 632 is inserted into the base handle shaft hole 211, and the threaded section 631 is engaged (e.g., meshed) with the first gear 23. When the motor 3 fails or there is no supply of power, the handle 6 can be inserted into the base handle shaft hole 211 and the housing handle shaft hole 222 of the gear box 2, and the handle 6 can be rotated clockwise to complete a lifting operation, and the handle can be rotated counterclockwise to complete a lowering operation. The handle 6 is flexible and convenient to assemble and simple to operate.

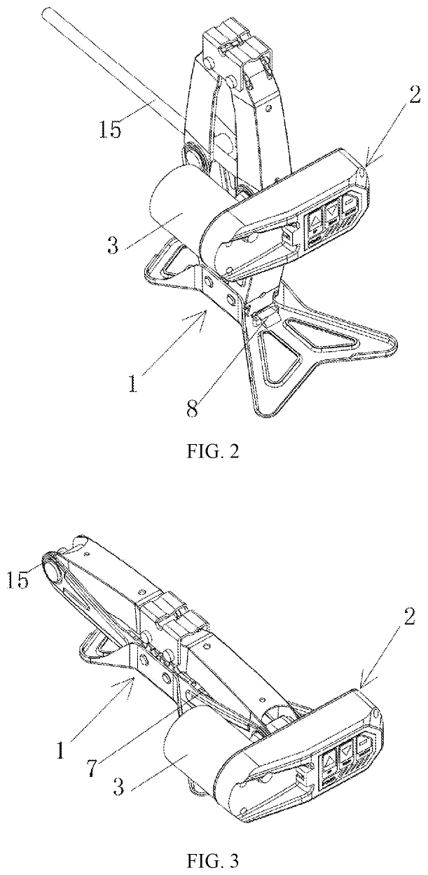

As illustrated in FIG. 2 and FIG. 3, in some embodiments, the scissors-type jack further includes a lowest position limit switch 7 and a highest position limit switch 8. The lowest position limit switch 7 is arranged on an inner side of one end of one lower supporting arm 13 of the pair of lower supporting arms 13 close to the bottom seat 11, and when the jack body 1 is lowered to a lowest limit position, the lower supporting arm 13 descends to trigger the lowest position limit switch 7. The highest position limit switch 8 is disposed on the bottom seat 11 and close to a position where the bottom seat 11 is hinged to the pair of lower supporting arms 13, and when the jack body 1 is lifted to a highest limit position, an end portion of a lower end of one lower supporting arm 13 of the pair of lower supporting arms 13, i.e., the end hinged to the bottom seat 11, abuts against the highest position limit switch 8 to trigger the highest position limit switch 8. The lowest position limit switch 7 and the highest position limit switch 8 are individually electrically connected to the control board 5. When the jack body 1 reaches the lowest or highest limit position, the limit switch at the corresponding position is triggered, and the control board 5 controls the motor 3 to be powered off, thereby realizing the position-limiting effect.

What is claimed is:

1. A scissors-type jack, comprising: a jack body (1), a gear box (2), a motor (3), and a battery pack (4);
wherein the jack body (1) comprises a bottom seat (11), a top support (12), a pair of lower supporting arms (13), a pair of upper supporting arms (14), and a screw rod (15); lower ends of the pair of lower supporting arms (13) are hinged to the bottom seat (11), upper ends of the pair of upper supporting arms (14) are hinged to the top support (12), upper ends of the pair of lower supporting arms (13) are respectively hinged to lower ends of the pair of upper supporting arms (14) through a pair of hinge shafts (16), the screw rod (15) penetrates between screw holes of the pair of hinge shafts (16), and the gear box (2) is fixed to one of the pair of hinge shafts (16);
wherein the scissors-type jack further comprises a control board (5), the gear box (2) comprises a base (21), a housing (22), a first gear (23), and a second gear (24); the base (21) is fixedly mounted with the one of the pair of hinge shafts (16) of the jack body (1), the housing (22) is fitted with the base (21), and a side of the housing (22) facing towards the base (21) is formed with a gear box cavity (221); the first gear (23), the second gear (24) and the battery pack (4) are arranged on a side of the base (21) facing towards the housing (22), a gear transmission shaft (231) of the first gear (23) is rotatably arranged on the base (21) and engaged with the second gear (24), the second gear (24) is connected to an end of the screw rod (15), the motor (3) is mounted on a side of the base (21) facing towards the jack body (1), a motor gear shaft (31) of the motor (3) penetrates through the base (21) and is engaged with the first gear (23), the control board (5) is disposed on an outer side of the battery pack (4) and electrically connected to the battery pack (4) and the motor (3) individually, and the control board (5) is configured to control the motor (3) to lift or lower the jack body (1).

2. The scissors-type jack according to claim 1, wherein the control board (5) is provided with an up key (51), a down key (52), and a switch key (53); the up key (51) is configured to control the jack body (1) to lift, the down key (52) is configured to control the jack body (1) to lower, and the switch key (53) is configured to control the motor (3) to be powered on or off.

3. The scissors-type jack according to claim 2, wherein the control board (5) is further provided with an overload protection chip (54), and the overload protection chip (54) is configured to carry out overload current protection on the battery pack (4) to thereby avoid overload use of the scissors-type jack.

4. The scissors-type jack according to claim 1, wherein the scissors-type jack further comprises a handle (6), the base (21) is provided with a base handle shaft hole (211) at a position close to the first gear (23), and the housing (22) is provided with a housing handle shaft hole (222) corresponding to the base handle shaft hole (211); the handle (6) comprises a gripping bar (61), a transverse bar (62), and a linkage bar (63); one end of the transverse bar (62) is perpendicularly connected to the gripping bar (61), one end of the linkage bar (63) is perpendicularly connected to the other end of the transverse bar (62) and extends along a direction facing away from the gripping bar (61), the other end of the linkage bar (63) is formed with a threaded section (631), an end of the threaded section (631) is tapered to form a connecting shaft (632), the linkage bar (3) penetrates through the housing handle shaft hole (222), the connecting shaft (632) is inserted into the base handle shaft hole (211), and the threaded section (631) is engaged with the first gear (23).

5. The scissors-type jack according to claim 1, wherein the base (21) is provided with a base bearing cavity (212) at a position corresponding to the gear transmission shaft (231), a base bearing (213) is arranged in the base bearing cavity (212), the housing (22) is provided with a housing bearing cavity (223) at a position corresponding to the base bearing cavity (212), a housing bearing (224) is arranged in the housing bearing cavity (223), and two ends of the gear transmission shaft (231) are respectively connected to the base bearing (213) and the housing bearing (224).

6. The scissors-type jack according to claim 1, wherein the scissors-type jack further comprises a lowest position limit switch (7) configured to limit a lowest position of lowering of the jack body (1) and a highest position limit switch (8) configured to limit a highest position of lifting of the jack body (1), the lowest position limit switch (7) and the highest position limit switch (8) are electrically connected to the control board (5) individually.
